(19) United States
(12) Patent Application Publication
(10) Pub. No.: US 2008/0206632 A1
(43) Pub. Date: Aug. 28, 2008

(54) BATTERY SEPARATOR

(76) Inventors: Ruike R. WANG, Lexington, MA (US); Ou Mao, Pleasanton, CA (US); Jonathan M. Boulton, North Attleboro, MA (US); George Cintra, Holliston, MA (US); Tatjana Mezini, Medford, MA (US)

Correspondence Address: FISH & RICHARDSON P.C., P.O. BOX 1022, MINNEAPOLIS, MN, 55440-1022, US

(21) Appl. No.: 11/678,493

(22) Filed: Feb. 23, 2007

(51) Int. Cl. H01M 2/00

(52) U.S. Cl. 429/163

(57) ABSTRACT

An alkaline battery includes a housing, a cathode disposed within the housing, an anode disposed within the housing, a separator disposed between the anode and the cathode, and an alkaline electrolyte contacting the anode and the cathode. The separator can include a tube having at an inner tube layer and an outer tube layer. The inner tube layer is disposed radially inward from the outer tube layer and no portion of the inner tube layer is disposed radially outward from any portion of the outer tube layer. The separator can also include a disc positioned at one end of the tube to create a closed end of the separator.

### TECHNICAL FIELD

This document relates to batteries, and more particularly to a separator for a battery.

### BACKGROUND

Batteries, such as alkaline batteries, are commonly used as electrical energy sources. Generally, a battery contains a negative electrode (anode) and a positive electrode (cathode). The anode contains an active material (e.g., zinc particles) that can be oxidized; and the cathode contains an active material (e.g., manganese dioxide) that can be reduced. The active material of the anode is capable of reducing the active material of the cathode. In order to prevent direct reaction of the active material of the anode and the active material of the cathode, the electrodes are electrically isolated from each other by a separator.

When a battery is used as an electrical energy source in a device, such as a cellular telephone, electrical contact is made to the electrodes, allowing electrons to flow through the device and permitting the respective oxidation and reduction reactions to occur to provide electrical power. An electrolyte in contact with the electrodes contains ions that flow through the separator between the electrodes to maintain charge balance throughout the battery during discharge.

### SUMMARY

An alkaline battery is disclosed that includes a housing, a cathode disposed within the housing, an anode disposed within the housing, a separator disposed between the anode and the cathode, and an alkaline electrolyte contacting the anode and the cathode. The separator includes a tube having at an inner tube layer and an outer tube layer. The inner tube layer is disposed radially inward from the outer tube layer and no portion of the inner tube layer is disposed radially outward from any portion of the outer tube layer. The separator also includes a disc positioned at one end of the tube to create a closed end of the separator.

In some implementations, the inner tube layer and/or the outer tube layer may be seamless layers. In some implementations, the inner tube layer and/or the outer tube layer may have seams. The seams may be non-aligned and/or circumferentially offset. A seam for either the inner tube layer or the outer tube layer can include a gap between opposing edges of the tube layer, or opposing edges of each seam for each tube layer can abut, or the opposing edges of each seam for each tube layer can overlap.

A method of making a battery is also disclosed. The method includes conditioning a supply of seamless tubing through a plurality of spools to alter the dimensions of the seamless tubing, inserting a mandrel into at least a portion of the conditioned seamless tubing, cutting the conditioned seamless tubing to a predetermined length to produce a seamless separator tube, and positioning the conditioned seamless separator tube within a housing of a battery with the mandrel. In some implementations, the method also includes uniting the seamless separator tube with an end disc to provide the seamless separator tube with a closed end.

The term “tube” as used in this document refers to any hollow, elongated body. A “tube” can have a cylindrical body or can have side walls forming other cross-sectional shapes including squares, rectangles, triangle, hexagons, pentagons, octagons, semi-circles, and ellipsoids.

A “seam” could include an abutment of material, an overlap of material, or even gap between portions of material. The term “seam” as used herein does not include mere folds or creases in material, thus a “seamless” tube could include portions where a crease remains from a previous fold of the material, have other folds or overlaps of material, or be a truly annular tube.

The details of one or more implementations are set forth in the accompanying drawings and the description below. Other features, objects, and advantages of the various implementations will be apparent from the description and drawings, and from the claims.

### DESCRIPTION OF DRAWINGS

FIG. 1 depicts a cross-sectional view of an implementation of a battery.

FIG. 2 depicts an exploded side view of an implementation of inserting a separator into a battery housing.

FIG. 3 depicts a prospective view of an implementation of a separator of a battery.

FIGS. 4A-4E depict top views of various implementations of separators of batteries.

FIG. 5 depicts a prospective view of an implementation of a separator of a battery.

FIG. 6 depicts a top view of an implementation of a separator of a battery.

FIGS. 7A-7D depict prospective views of various implementations of tube layers of separators of batteries.

FIG. 8A depicts a prospective view of an implementation of a separator of a battery.

FIG. 8B depicts a top view of the implementation shown in FIG. 8A.

FIG. 9 depicts an implementation of providing a tube layer of a separator.

FIG. 10 depicts an implementation of positioning a tube layer of a separator within a battery housing.

FIG. 11 depicts a top view of an annular seamless tube.

FIG. 12 depicts an a chart of the drain rate verses signature capacity for a “zero” overlap implementation, a conventional tube/disc configuration, and a conventional X-placed configuration.

Like reference symbols in the various drawings indicate like elements.

### DETAILED DESCRIPTION

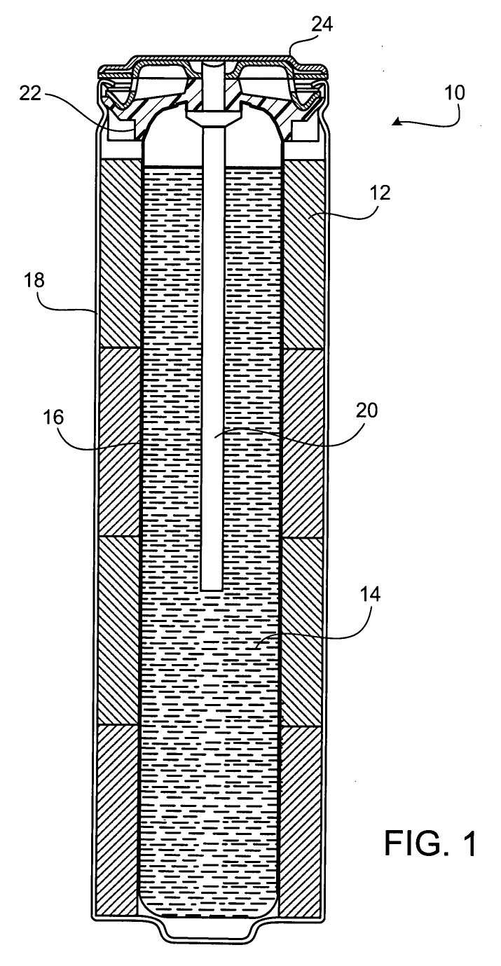

Referring to FIG. 1, a battery 10 includes a cylindrical housing 18 containing a cathode 12, an anode 14, and a separator 16 between the cathode and anode. Cathode 12 includes an active cathode material, and anode 14 includes an active anode material. Battery 10 also includes a current collector 20, a seal 22, and a metal top cap 24, which serve as the negative terminal for the battery. Cathode 12 is in contact with housing 18, and the positive terminal of battery 10 is at the end of the battery opposite from the negative terminal. An electrolyte is dispersed throughout battery 10. In order to prevent direct reaction of the active material of the anode 14 and the active material of the cathode 12, the electrodes are electrically isolated from each other by a separator 16.

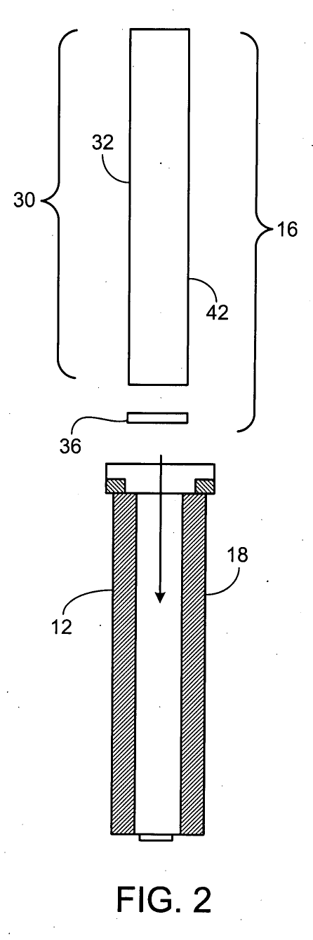

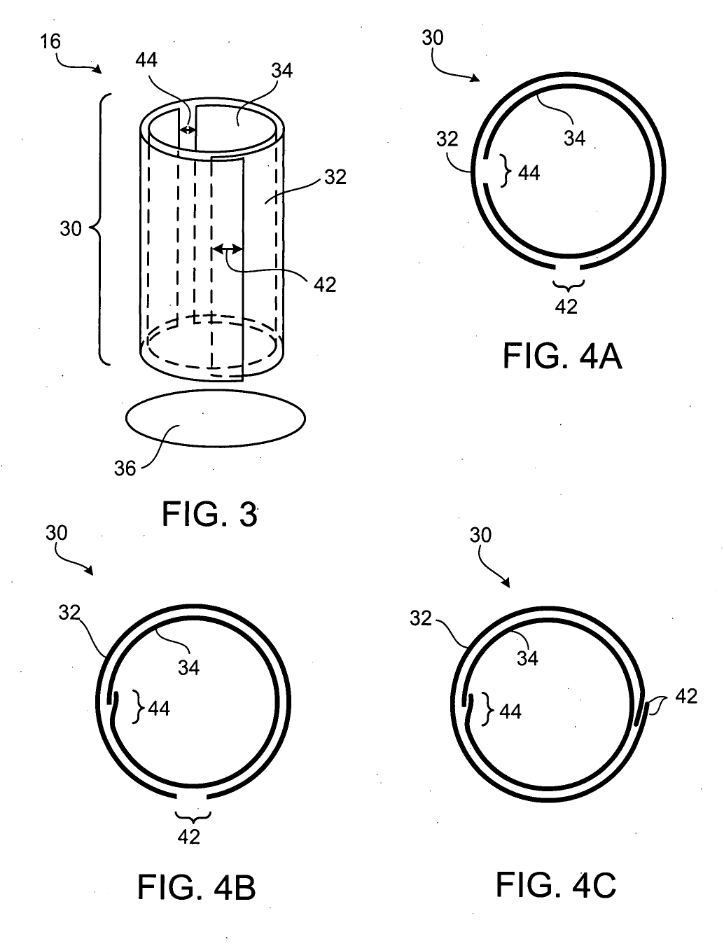

As shown in FIG. 2, the battery can be assembled by placing the separator 16 within a cylindrical housing 18 to the interior of material forming a cathode 12. Separator 16 includes a tube 30 and a disc 36. In some implementations, the disc 36 can be crimped around the bottom of the tube 30 to form a closed end of the separator 16. Disc 36 can also form a bottom closed end of separator 16 by mere positioning at the bottom end of tube 30 or can be attached by adhesive. FIG. 2 also depicts the outer tube layer 32 of the tube 30 and a outer tube layer seam 42. In some implementations described below, the outer tube layer 32 can be seamless. Tube 30 may also include an inner tube layer 34. In some implementations, tube 30 may include additional layers. FIGS. 3-8B, described below, depict various implementations of separator 16, tube 30, and/or one of the tube layers 32 or 34.

As can be seen in FIGS. 3, 4A-4E, 5, 6, and 8A-8B, the separator 16 may include a tube 30 with an outer tube layer 32 and an inner tube layer 34. As can be seen in FIGS. 3, 4A-4E, 5, 6, and 8A-8B, the inner tube layer 34 is disposed radially inward from the outer tube layer 32 and no portion of the inner tube layer 34 is disposed radially outward from the outer tube layer 32. This is true even for the implementation shown in FIGS. 8A and 8B which have non-circular tube layer cross-sections. Although FIGS. 3, 4A-4E, 5, 6, and 8A-8B include spacing between the inner tube layer 44 and the outer tube layer 32, some implementations will not include spacing between the tube layers 32 and 34.

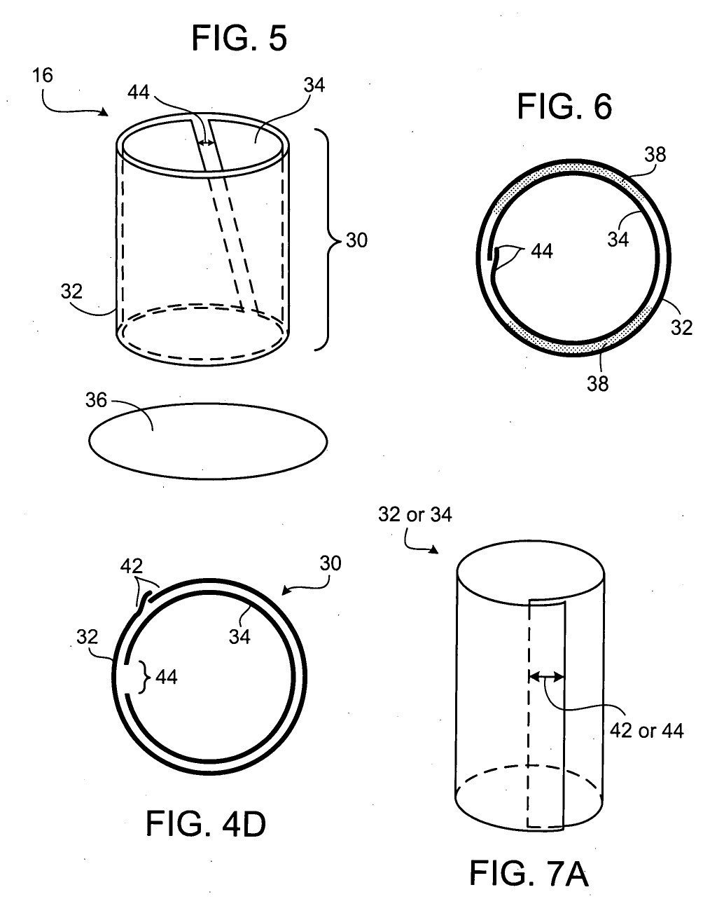

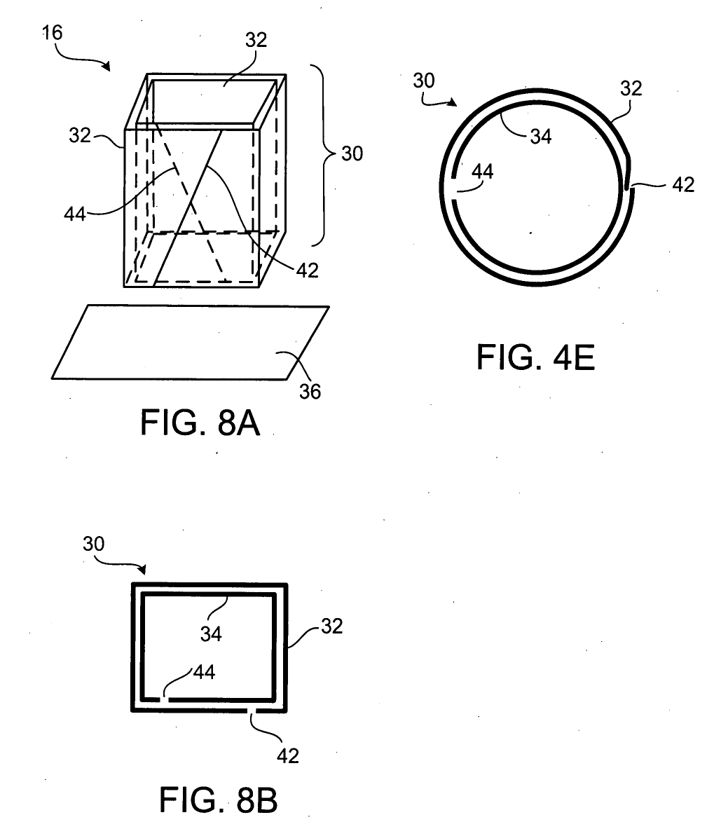

In the implementations shown in FIGS. 3, 4A-4E, and 8A-8B, both tube layers 32 and 34 include seams 42 and 44 respectively. In some implementations, the seams 42 and 44 can be offset. As shown in FIG. 3, the seams may be offset by approximately 180 degrees. In other implementations, such as those shown in FIGS. 4A-4E, the seams may be offset by any angle, such as by about 90 degrees. In implementations where the seam includes overlapped or abutting opposite ends of a piece of material, the seam may include adhesive to secure the seam. In some implementations, the mere presence of the other parts of the battery will maintain the desired arrangement of the opposite ends of the piece of material forming the tube layer. In the implementations shown in FIGS. 5 and 6, the outer tube layer 32 is a seamless layer, but inner tube layer 34 is shown to have a seam 44. In other implementations not shows, inner tube layer 34 can be a seamless tube layer in combination with a outer tube layer 32 either having or not having a seam.

As shown in FIG. 3, each tube layer 32 and 34 can be formed from generally rectangular continuous pieces of material by curving opposite ends of the generally rectangular continuous pieces of material to form the tube layers 32 and 34. In other implementations, tube layers 32 or 34 can be formed from non-rectangular pieces of material and/or can be formed out of non-continuous pieces of material. As shown in FIG. 3, opposite ends of a generally rectangular continuous pieces of material form seams 42 and 44. Outer tube layer 32 includes a seam 42 that includes an overlap of the material, while inner tube layer 34 includes a seam 44 that includes a gap between the opposite ends of the continuous piece of material. In other implementations, the inner tube layer and the outer tube layer can each have seams that include an overlap of opposite ends of a continuous piece of material, a gap between opposite ends of a continuous piece of material, or even an abutment of the opposite ends of a continuous piece of material.

FIG. 4A depicts an implementation of a tube 30 where both outer tube layer 32 is and inner tube layer 34 include seams 42 and 44 which include gaps between opposite ends of material forming each layer. Seam 42 is offset from seam 44 by about 90 degrees. FIG. 4B depicts an implementation of tube 30 where the outer tube layer 32 includes a seam 42 having a gap between opposite ends of material forming the outer tube layer 32 and where the inner tube layer 34 includes a seam 44 having an overlap between opposite ends of material forming the inner tube layer 34. The seams 42 and 44 are offset by an angle somewhat greater than 90 degrees. FIG. 4C depicts an implementation of tube 30 where both the outer tube layer 32 and the inner tube layer 34 have seams 42 and 44 that have overlaps. Seams 42 and 44 are offset by about 180 degrees. FIG. 4D depicts a tube 30 having an outer tube layer 32 with an overlapped seam 42 and an inner tube layer 34 having a gapped seam 44. Overlapped seam 42 is offset from gapped seam 44 by about 60 degrees. FIG. 4E depicts an implementation where both the inner tube layer 34 and outer tube layer 32 have seams that approximately abut. As shown, FIG. 4E depicts a slight gap between the opposite ends of the material forming the tube layers 32 and 34. This slight gap shown in FIG. 4E is intended to show an abutment of the material forming the tube layers 32 and 34, but the slight gap includes to indicate the placement of the seams 42 and 44. In practice, opposite ends forming seams 42 and 44 contact each other when abutting. Although shown with both tube layers having abutting seams, other implementations my include inner or outer tube layers combined with inner or outer tube layers having gapped seams and/or overlapped seams.

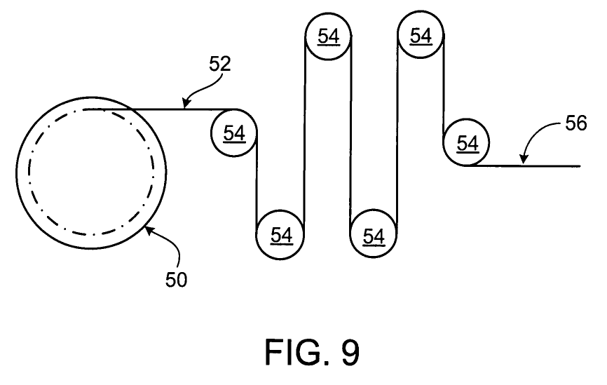

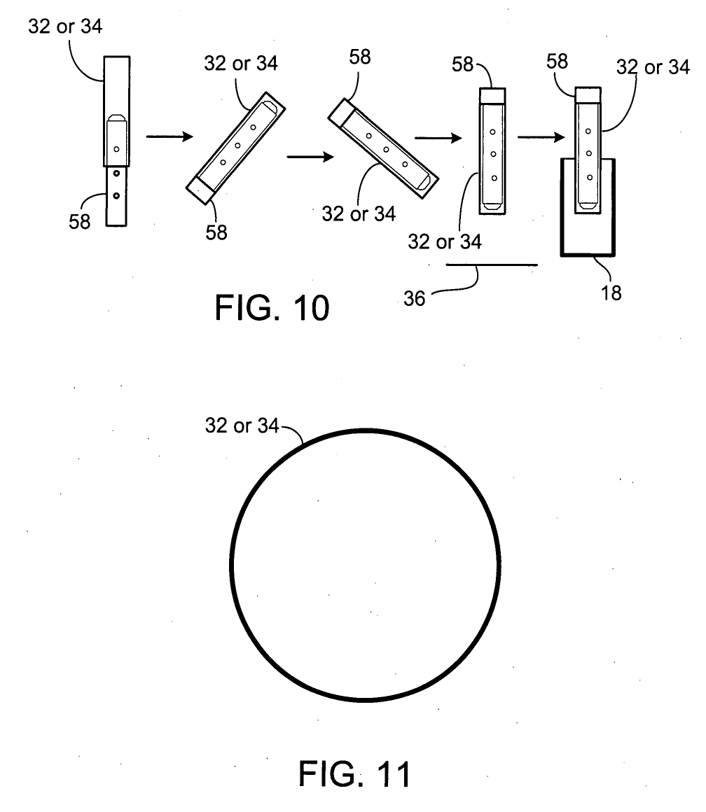

Referring to FIG. 5, the outer tube layer 32 can be a seamless tube layer. A seamless tube layer can have creases and even folds. A seamless tube layer may form a continuous side wall. A process for providing a seamless tube is disclosed below in reference to FIGS. 9 and 10. The implementation shown in FIG. 5 further includes an inner tube layer 34 that includes a gapped seam 44. In other implementations, the inner tube layer 34 can also be a seamless tube. In some implementations, such as that shown in FIG. 6, the inner tube layer 34 can include an overlapped seam 44. In still other implementations, the inner tube layer 34 can have a seam 44 having abutting opposite ends of the material forming the tube layer. In other implementations, the inner tube layer 34 can be a seamless tube and the outer tube layer 32 include a seam.

As shown in FIG. 6, the tube 30 can also include an intermediate layer of adhesive 38 between the inner tube layer 34 and the outer tube layer 32. Adhesive layer 38 can be continuous or discontinuous (as shown). An adhesive layer may also be applied between overlapping opposite ends of an overlapped seam or between the abutting opposite ends of an abutting seam. Although the use of adhesive layer 38 is only shown in use with a seamless outer tube layer 32, adhesive layer 38 can also be used in conjunction with any of the other implementations disclosed herein.

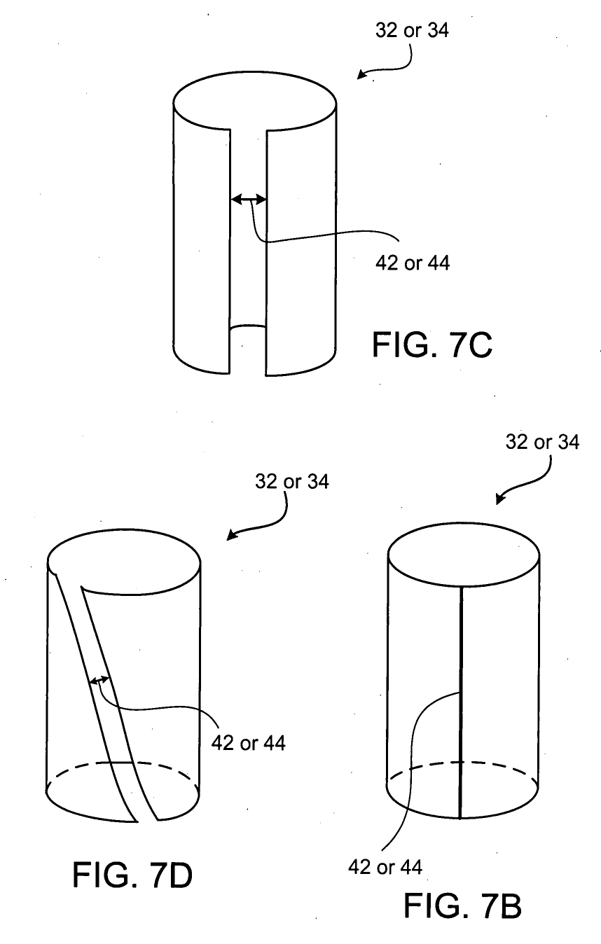

FIGS. 7A-7D depict various implementations of seams 42 or 44 for tube layers 32 or 34. FIG. 7A depicts an overlapped seam 42 or 44. FIG. 7B depicts a seam 42 or 44 with abutting ends. FIGS. 7C and 7D depict gapped seams 42 or 44. In some implementations, for example those shown in FIGS. 7A-7C, the seam 42 or 44 is parallel with the length of the tube layer 32 or 34. In other implementations, the seam 42 or 44 may have other arrangements, such as being diagonal to the length of the tube 32 or 34, curved, or zigzagged. In some implementations, the seam 42 or 44 may include both gapped, overlapping, and/or abutting portions. Seams 42 or 44 having a seam that is not parallel to the length of the tube (such as that shown in FIG. 7D) can also be gapped, abutted, overlapped, or a combination thereof.

The tube layers 32 or 34 shown in FIGS. 7A-7C are formed by curving a generally rectangular piece of continuous separator material into a tube with the opposite ends of the generally rectangular piece of continuous separator material being placed in close proximity to form the seam 42 or 44. Starting separator material of other shapes will form seams 42 or 44 having different arrangements. In some implementations, the bottom and top sides of the separator material are generally linear and parallel.

Referring to FIG. 7A, in some implementations, each tube layer 32 or 34 with an overlapped seam can have an overlap that is less than about 20% of the circumference of the tube body 32 or 34. In some implementations, the overlap can be less than about 10% of the circumference of the tube body 32 or 34. By using tube layers 32 and 34 each having less than a 10% overlapped seam 42 and 44 (which includes seams having abutting opposite ends or gaps between opposite ends) in an AA cell, the material savings per cell can exceed about 15% and at least about 1% internal volume of the battery housing can be freed up verses a tube/disc configuration having a tube formed from laminated layers having a 30% overlap. It is noted that a tube formed from laminated layers having a 30% overlap results in a portion of an inner tube layer disposed radially outward from a portion of the outer tube layer.

Referring to FIGS. 7C and 7D, in some implementations, each tube layer 32 or 34 with a gapped seam can have a gap that is no more than about 10% of the circumference of the tube 30. In some implementation, each gapped seam 42 or 44 has a gap less than about 5% of the circumference of the tube 30.

Referring to FIGS. 8A and 8B, tube bodies 32 and 34 need not be generally cylindrical. In some implementations, such as those shown in FIGS. 8A and 8B, the tube 30 and the respective tube bodies 32 and 34 can have non-circular cross-sectional shapes such as square or rectangular shapes. In other implementations, the tube 30 may have a cross sectional shape of a trapezoid, a triangle, a pentagon, a hexagon, an octagon, a semi-circle or an ellipsoid. The implementations shown in FIGS. 8A and 8B has both inner and outer tube layers having abutting seams. In other implementations, the inner and/or outer tube layers 32 and 34 may be seamless, may have overlapped seams, or may have gapped seams. As show in FIGS. 8A and 8B, the seams 42 and 44 are both diagonal and cross each other, thus these two seams are non-aligned even though a portion of the seams are not offset.

Also as shown, disc 36 may also have a non-circular shape. In the implementation shown in FIG. SA, disc 36 has a rectangular shape, but in other implementations, the disc 36 may have other suitable shapes such as trapezoid, a triangle, a pentagon, a hexagon, an octagon, a semi-circle or an ellipsoid. In some implementations, the shape of the disc will correspond to the cross sectional shape of tube 30. In some implementations, the disc 36 has a larger surface area than the cross sectional area of the tube 30. Disc 36 can also be made out of conventional separator materials.

Suitable materials for the separator include paper, polypropylene (e.g., non-woven polypropylene or microporous polypropylene), polyethylene, polytetrafluoroethylene, a polyamide (e.g., a nylon), a polysulfone, a polyvinyl chloride, or combinations thereof. Suitable separator papers include PDM PA25A paper; BH40, manufactured by Nippon Kodishi Corporation, and DURALAM DT225AC paper. Separator 16 can also include a tube layer of cellophane combined with a tube layer of a non-woven material. In some implementations, the outer tube layer 32 includes cellophane and the inner tube layer 34 includes a non-woven material. The non-woven material can include, for example, polyvinyl alcohol and/or rayon. Each of these materials is usually available as continuous sheets of flat material, which is then formed into a tube layer 32 or 34. Each flat continuous piece of separator material may include various bonded sub-layers of different materials. Tube layers making up the separator 16 may be porous or non-porous. In some implementations, the inner tube layer is porous and the outer tube layer is non-porous. In other implementations, the inner tube layer is non-porous and the outer tube layer is also non-porous.

Referring to FIGS. 9 and 10, a seamless tube layer 32 or 34 can be manufactured by a process of preconditioning and tensioning a preformed tube into the desired final dimensions, cutting the tube to a desired length, and placing the tube layer 32 or 34. As show in FIG. 9, a seamless separator tube 52 can come on a coil 50 as a tube of indefinite length. In some implementations, the seamless separator tube 52 provided on the coil 50 does not posses the final dimensions with respect to circumference and wall thickness as the seamless tube layer 32 or 34. The seamless separator tube 52 provided on the coil 50 can be manufactured by any conventional technique, such as by extrusion, blow-extrusion, or processed from a solution of the polymer dissolved in an appropriate solvent (e.g. a solution of the polymer is passed through an annular die of the appropriate dimension into a coagulating to form the tube of the desired diameter). In some implementations, the seamless separator tube 52 while on the coil 50 may be folded down to close the seamless separator tube 52 while in storage, which may cause a set of creases along the sides of the seamless separator tube 52. In other implementations, the seamless separator tube 52 may be provided directly from an extruder, a blow-extruder, or other tube forming device. To pre-condition and tension control the seamless separator tube 52 into the final desired dimensions, the seamless separator tube 52 can be passed through a series of spools 54. These spools 54 can have various configurations and rotating speeds to cause the seamless separator tube 52 to be formed into the final desired dimensions. In some implementations, the spools 54 can also cause the seamless separator tube 52 to open up. After passing through the series of spools 54, the conditioned and tension controlled tube 56 then is inserted onto a mandrel 58 and cut to form a tube body 32 or 34.

As shown in FIG. 10, the mandrel 58 can then move and/or rotate the tube body 32 or 34 into a desired orientation, combine the tube body 32 or 34 with a disc 36 to form a separator 16, and place the separator 16 into a battery housing 18. In some implementations, the cathode 12 may already be present within the batter housing 18 during the placement of the separator 16. Mandrel 58 can also be provided with a pneumatic device to grip and release separator materials. Mandrel 58 can also be provided with other devices for gripping and releasing separator materials. In some implementations, the tube body 32 or 34 will be a truly annular tube as shown in FIG. 11. In other embodiments, the seamless tube body 32 or 34 may include portions where a crease remains from a previous fold of the material or have other folds or overlaps of material.

In some implementations, the seamless tube body 32 or 34 can be the only wall layer of the separator 16. In some implementations, the seamless separator tube 52 may include various sub-bonded layers, thus the movement of the seamless separator tube 52 through spools 54 and cutting creates at least inner and outer tube layers 34 and 32, both being seamless. Two seamless tube layers can also be created by two separate operations of pre-conditioning two different seamless separator tubes 52 and inserting the conditioned and tension controlled tubes 56 onto a common mandrel 58. In other implementations, mandrel 58 may be wrapped with separator material prior to inserting the conditioned and tension controlled tube 56 over the mandrel 58 to create an inner tube layer 34 having a seam. In other implementations, separator material may be wrapped around a seamless inner tube layer 34 while on the mandrel 58 prior to combination with the disc 36 to produce the outer tube layer 32 having a seam.

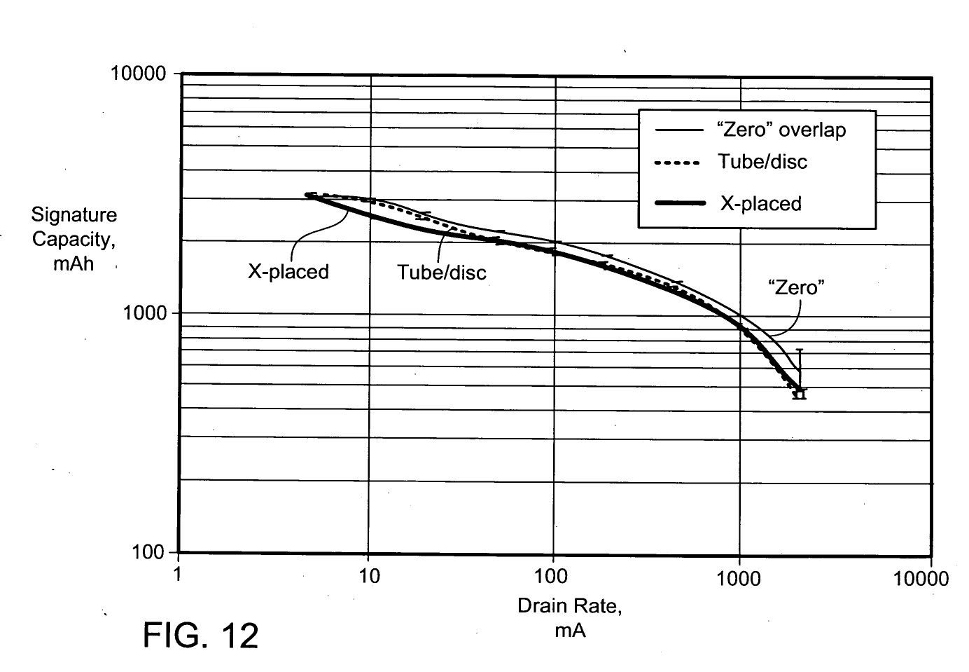

Table 1, below, and FIG. 12 show a plot of capacity versus drain rate from 2 A to 5 mA comparing the performance of AA cells with a “zero” overlap configuration similar to that shown in FIG. 4E verses a tube/disc arrangement of laminated layers with a 30% overlap, verses an x-placed arrangement. As shown in Table 1, the “zero” overlap configuration results in about a 10% performance increase across the 10 mA-1 A range. At a high rate, this performance gain can be significant. As shown in Table 1 in the ANSI Digital Camera test, the “zero” overlap configuration results in a 67% gain verses the x-placed configuration and a 28% gain verses the tube/disc arrangement having laminated layers with a 30% overlap. In the ANSI CD test, the “zero” overlap configuration results in a 3% gain verses the x-placed configuration.

TABLE 1
Table 1 AA using “zero” overlap separator versus
tube/disc and x-placed separator

| | Signature capacity (mAh) or device test | | | | | |
|---|---|---|---|---|---|---|
| | “Zero” overlap¹ | | Tube/disc | | | |
| Drain | (Vs. X-placed) | | (Vs. X-placed) | | X-placed | |
| 2 A | 593 mAh | (+27%) | 475 mAh | (+2%) | 466 | mAh |
| ANSI | 87 pulses | (+67%) | 68 pulses | (+31%) | 52 | pulses |
| Digi Cam | | | | | | |
| 1 A | 1014 mAh | (+17%) | 944 mAh | (+9%) | 866 | mAh |
| 0.5 A | 1342 mAh | (+13%) | 1291 mAh | (+9%) | 1189 | mAh |
| 0.25 A | 1639 mAh | (+11%) | 1598 mAh | (+8%) | 1478 | mAh |
| ANSI | 7.8 h | (+3%) | TBM | | 7.59 | h |
| audio CD | | | | | | |
| 0.1 A | 2062 mAh | (+12%) | 2065 mAh | (+13%) | 1835 | mAh |
| 50 mA | 2259 mAh | (+8%) | 2241 mAh | (+7%) | 2098 | mAh |
| 25 mA | 2498 mAh | (+13%) | 2412 mAh | (+9%) | 2218 | mAh |
| 10 mA | 3087 mAh | (+22%) | 3072 mAh | (+22%) | 2522 | mAh |

Referring back to FIG. 1, cathode 12 includes at least one cathode active material.

In some implementations, cathode 12 can further include at least one conductive aid and/or at least one binder. The electrolyte also is dispersed through cathode 12. The weight percentages provided herein with respect to components of cathode 12 are determined after the electrolyte has been dispersed through cathode 12.

In some implementations, the cathode active material can be a manganese oxide (MnO₂). Other examples of cathode active materials include copper oxides (e.g., cupric oxide (CuO), cuprous oxide (Cu₂O)); copper hydroxides (e.g., cupric hydroxide (Cu(OH)₂), cuprous hydroxide (Cu(OH))); cupric iodate (Cu(IO₃)₂); AgCuO₂; LiCuO₂; Cu(OH)(IO₃); Cu₂H(IO₆); copper-containing metal oxides or chalcogenides; copper halides (e.g., CuCl₂); and/or copper manganese oxides (e.g., Cu(MnO₄)₂). Further examples of cathode active materials include cathode active materials that include nickel, such as a nickel oxyhydroxide (NiOOH). Additional examples of cathode active materials include cathode active materials including a pentavalent bismuth-containing metal oxide. In certain implementations, cathode 12 can be porous. A porous cathode can include, for example, one or more of the above-described cathode active materials (e.g., MnO₂, NiOOH).

A conductive aid can increase the electronic conductivity of cathode 12. An example of a conductive aid is carbon particles, which can be any of the conventional carbon particles used in cathodes, including graphite particles. Cathode 12 may include, for example, from about three percent to about nine percent (e.g., from about four percent to about seven percent) carbon particles by weight. In some implementations, cathode 12 can include from about four percent to about nine percent (e.g., from about four percent to about 6.5 percent) graphite particles by weight. Another example of a conductive aid is carbon fibers, such as those described in Luo et al., U.S. Pat. No. 6,858,349, and in Anglin, U.S. Patent Application Publication No. US 2002/0172867 A1, published on Nov. 21, 2002, and entitled “Battery Cathode”. In certain implementations, cathode 12 can include from about one percent by weight to about 10 percent by weight of total conductive aids, which may include more than one type of conductive aid.

Examples of binders include polyethylene powders, polyacrylamides, Portland cement and fluorocarbon resins, such as polyvinylidenefluoride (PVDF) and polytetrafluoroethylene (PTFE). Cathode 12 may include, for example, up to about two percent binder by weight (e.g., up to about one percent binder by weight). In certain implementations, cathode 12 can include from about 0.1 percent to about two percent (e.g., from about 0.1 percent to about one percent) binder by weight.

Cathode 12 can include other additives. Additives are disclosed, for example, in Mieczkowska et al., U.S. Pat. No. 5,342,712. In some implementations, cathode 12 can include titanium dioxide (TiO₂). In certain implementations, cathode 12 can include from about 0.1 percent to about two percent (e.g., from about 0.2 percent to about two percent) TiO₂ by weight.

The electrolyte that is dispersed through cathode 12 (and/or the electrolyte used in the rest of battery 10) can be any of the electrolytes used in batteries. In some implementations, cathode 12 can include from about five percent to about eight percent (e.g., from about six percent to about seven percent) electrolyte by weight. The electrolyte can be aqueous. An aqueous electrolyte can be an alkaline solution, such as an aqueous hydroxide solution (e.g., NaOH, KOH), or a mixture of hydroxide solutions (e.g., NaOH/KOH). For example, the aqueous hydroxide solution can include from about 33 percent by weight to about 40 percent by weight of the hydroxide material, such as about 9N KOH (about 37 percent by weight KOH). In some implementations, the electrolyte can also include up to about four percent by weight (e.g., about two percent by weight) of zinc oxide.

The electrolyte can include other additives. As an example, the electrolyte can include a soluble material (e.g., an aluminum material) that reduces (e.g., suppresses) the solubility of the cathode active material in the electrolyte. In certain implementations, the electrolyte can include one or more of the following: aluminum hydroxide, aluminum oxide, alkali metal aluminates, aluminum metal, alkali metal halides, alkali metal carbonates, or mixtures thereof. Electrolyte additives are described, for example, in Eylem et al., U.S. Patent Application Publication No. US 2004/0175613 A1, published on Sep. 9, 2004, and entitled “Battery”.

Housing 18 can be any housing commonly used in batteries. As shown, housing 18 is a cylindrical housing. In other implementations, the housing can have other shapes, such as shapes. In some implementations, housing 18 can be made of a metal or a metal alloy, such as nickel, nickel-plated steel (e.g., nickel-plated cold-rolled steel).

In some implementations, housing 18 can include an inner metal wall and an outer electrically non-conductive material such as heat-shrinkable plastic. Optionally, a layer of conductive material can be disposed between the inner wall and cathode 12. The layer may be disposed along the inner surface of the inner wall, along the circumference of cathode 12, or both. This conductive layer can be formed, for example, of a carbonaceous material (e.g., graphite). Such materials include, for example, LB 1000 (Timcal), Eccocoat 257 (W.R. Grace and Co.), Electrodag 109 (Acheson Colloids Co.), Electrodag 112 (Acheson), Vamiphite 5000 (Nippon), and EB0005 (Acheson). Methods of applying the conductive layer are disclosed, for example, in Canadian Patent No. 1,263,697.

Anode 14 can be formed of any of the zinc materials used in battery anodes. For example, anode 14 can be a zinc gel that includes zinc metal particles, a gelling agent, and minor amounts of additives, such as gassing inhibitor. Gassing inhibitors can be inorganic materials, such as bismuth, tin, lead and indium. Alternatively, gassing inhibitors can be organic compounds, such as phosphate esters, ionic surfactants or nonionic surfactants. Examples of ionic surfactants are disclosed, for example, in Chalilpoyil et al., U.S. Pat. No. 4,777,100. In addition, a portion of the electrolyte is dispersed throughout the anode.

Seal 22 can be made of, for example, a polymer (e.g., nylon).

Cap 24 can be made of, for example, a metal or a metal alloy, such as aluminum, nickel, titanium, or steel.

In some implementations, battery 10 can include a hydrogen recombination catalyst to lower the amount of hydrogen gas that may be generated in the cell by anode 14 (e.g., when anode 14 includes zinc). Hydrogen recombination catalysts are described, for example, in Davis et al., U.S. Pat. No. 6,500,576, and in Kozawa, U.S. Pat. No. 3,893,870. Alternatively or additionally, battery 10 can be constructed to include pressure-activated valves or vents, such as those described in Tomantschger et al., U.S. Pat. No. 5,300,371.

Weight percentages of battery components provided herein are determined after the electrolyte solution has been dispersed in the battery.

Battery 10 can be a primary electrochemical cell or a secondary electrochemical cell. Battery 10 can be of any of a number of different voltages (e.g., 1.5 V, 3.0 V, 4.0 V), and/or can be, for example, a AA, AAA, AAAA, C, or D battery. Battry 10 can have a multi cavity design and thus use multiple separators 16.

Methods for assembling electrochemical cells are described, for example, in Moses, U.S. Pat. No. 4,279,972; Moses et al., U.S. Pat. No. 4,401,735; and Keamey et al., U.S. Pat. No. 4,526,846.

A number of implementations have been described. Nevertheless, it will be understood that various modifications may be made without departing from the spirit and scope of this disclosure. Accordingly, other implementations are within the scope of the following claims.

What is claimed is:

1. An alkaline battery comprising:
(a) a housing;
(b) a cathode disposed within the housing;
(c) an anode disposed within the housing;
(d) a separator disposed between the anode and the cathode, the separator comprising:
a tube comprising at an inner tube layer and an outer tube layer, the inner tube layer disposed radially inward from the outer tube layer, wherein no portion of the inner tube layer is disposed radially outward from any portion of the outer tube layer;
a disc positioned at one end of the tube creating a closed end of the separator; and
(e) an alkaline electrolyte contacting the anode and the cathode.

2. The battery of claim 1, wherein the inner tube layer is a seamless layer.

3. The battery of claim 1, wherein the outer tube layer is a seamless layer.

4. The battery of claim 1, wherein the inner tube layer and the outer tube layer each comprise a seam.

5. The battery of claim 4, wherein the seams are non-aligned.

6. The battery of claim 5, wherein the seams are circumferentially offset.

7. The battery of claim 6, wherein the seam of the inner tube layer is oriented approximately 180° from the seam of the outer tube layer.

8. The battery of claim 4, wherein the seam for the inner layer comprises a gap between opposing edges of the inner tube layer.

9. The battery of claim 4, wherein the seam for the outer layer comprises a gap between opposing edges of the outer tube layer.

10. The battery of claim 4, wherein opposing edges of each seam for each tube layer at least abut.

11. The battery of claim 10, wherein the opposing edges of each seam for each tube layer overlap by no more than 20 percent of the circumference of each tube layer.

12. The battery of claim 10, wherein the opposing edges of each seam for each tube layer overlap by no more than 10 percent of the circumference of each tube layer.

13. The battery of claim 1, wherein both the inner tube layer and the outer tube layer are seamless.

14. The battery of claim 13, wherein the separator further comprises an intermediate adhesive layer bonding the inner tube layer to the outer tube layer.

15. The battery of claim 1, wherein the inner tube layer comprises a porous material and the outer tube layer comprises a non-porous material.

16. The battery of claim 1, wherein the inner tube layer comprises a non-porous material and the outer tube layer comprises a non-porous material.

17. An alkaline battery comprising:
(a) a cathode;
(b) an anode;
(c) a separator between the anode and the cathode, the separator comprising;
a tube, the tube comprising at an inner tube layer and an outer tube layer, the inner tube layer is disposed radially inward from the outer tube layer, wherein the inner tube layer and the outer tube layer each comprise a seam, and wherein the seams are non-aligned;
a disc positioned at one end of the tube creating a closed end of the separator; and
(d) an alkaline electrolyte contacting the anode and the cathode.

18. The battery of claim 17, wherein opposing edges of each seam for each tube layer do not overlap by more than 10 percent of the circumference of the tube, and wherein the opposing edges of each seam for each tube layer do not comprise a gap exceeding 10 percent of the circumference of the tube.

19. A method of making a battery, the method comprising:
conditioning a supply of seamless tubing through a plurality of spools to alter the dimensions of the seamless tubing;
inserting a mandrel into at least a portion of the conditioned seamless tubing;
cutting the conditioned seamless tubing to a predetermined length to produce a seamless separator tube; and
positioning the conditioned seamless separator tube within a housing of a battery with the mandrel.

20. The method of claim 19, further comprising uniting the seamless separator tube with an end disc to provide the seamless separator tube with a closed end.
